(19) United States
(12) Patent Application Publication
(10) Pub. No.: US 2017/0025854 A1
(43) Pub. Date: Jan. 26, 2017

(54) Acoustical Electrical Receptacles

(71) Applicant: AT&T Intellectual Property I, L.P., Atlanta, GA (US)

(72) Inventors: John Willis, Plano, TX (US); Kristin Patterson, Dallas, TX (US); Thomas Risley, Dallas, TX (US); Curtis Stephenson, McKinney, TX (US); David Vaught, Dallas, TX (US)

(73) Assignee: AT&T Intellectual Property I, L.P., Atlanta, GA (US)

(21) Appl. No.: 14/808,377

(22) Filed: Jul. 24, 2015

(51) Int. Cl. H02J 3/14

(52) U.S. Cl. CPC H02J 3/14; H02J 2003/143

(57) ABSTRACT

An electrical receptacle responds to acoustic inputs. A microphone integrated into the electrical receptacle generates electrical signals in response to the acoustic inputs. A network interface integrated into the electrical receptacle provides addressable communication with controllers, computers, and other networked devices. The electrical receptacle may thus be installed or retrofitted into the electrical wiring of all homes and businesses. Users may thus speak voice commands, which are received by the electrical receptacle and sent for voice control of appliances and other automation tasks.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Intercom systems can be found in many homes and businesses. These intercom systems allow occupants in different rooms to communicate. However, conventional intercom systems rely on dedicated wiring or wireless transmission. The dedicated wiring is expensive and usually installed during construction, thus becoming quickly outdated. Conventional wireless intercoms have limited range and interference issues.

### BRIEF DESCRIPTION OF THE SEVERAL VIEWS OF THE DRAWINGS

The features, aspects, and advantages of the exemplary embodiments are better understood when the following Detailed Description is read with reference to the accompanying drawings, wherein:

FIGS. 1-4 are simplified illustrations of an environment in which exemplary embodiments may be implemented;

FIGS. 5-8 are detailed illustrations of an electrical receptacle, according to exemplary embodiments;

FIG. 9 illustrates a socket area, according to exemplary embodiments;

FIGS. 10-15 are illustrations of a cover to the electrical receptacle, according to exemplary embodiments;

FIG. 16 illustrates an acoustic tube, according to exemplary embodiments;

FIG. 17 is a block diagram of microphone circuitry, according to exemplary embodiments; and

FIGS. 18-23 illustrate retrofit options, according to exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

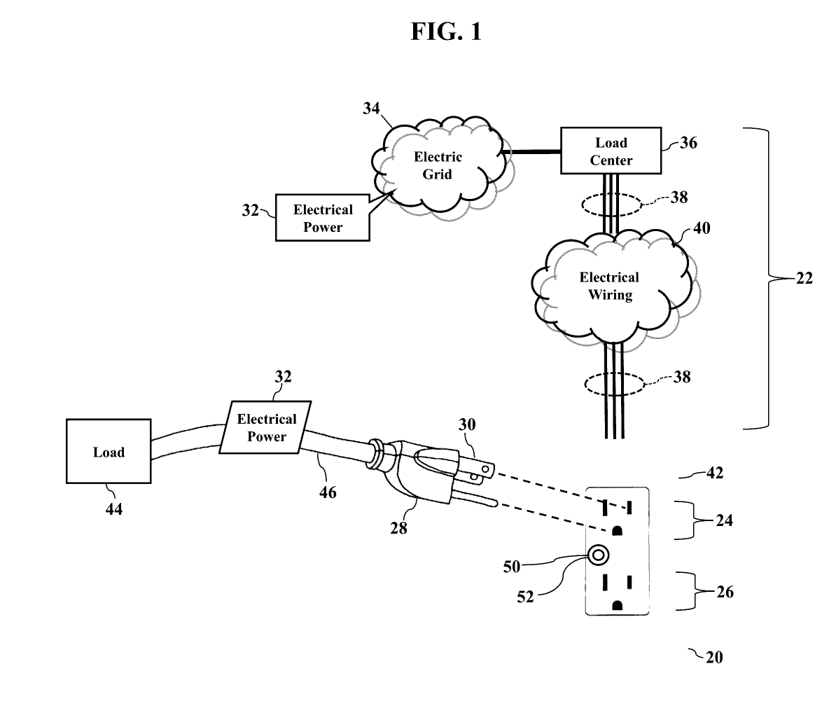

FIGS. 1-4 are simplified illustrations of an environment in which exemplary embodiments may be implemented. FIG. 1 illustrates an electrical receptacle 20 connected to a residential or business electrical wiring distribution system 22. The electrical receptacle 20 is illustrated as having two (2) conventional duplex outlet sockets 24 and 26, as is common in homes and businesses. As the reader understands, an electrical plug 28 has male blades and/or prongs 30 that insert into either outlet socket 24 or 26. Electrical power 32 (e.g., current and voltage) is delivered from the electric grid 34 to load center 36 in a home or business. The load center 36 has circuit breakers (not shown) contained within a panel. Conductors 38 in electrical wiring 40 distribute the electrical power 32 to the electrical receptacle 20. A wall plate 42 hides the physical connections to the conductors 38, thus providing a finished installation appearance. When the electrical plug 28 engages electrical receptacle 20, the electrical power 32 is delivered to some electrical load 44 (such as a lamp or other appliance). The electrical wiring distribution system 22 is very well known and thus need not be explained in greater detail.

Here, though, the electrical receptacle 20 is acoustically responsive. That is, the electrical receptacle 20 also detects sounds in the vicinity of its installed location. The reader is likely familiar with a microphone, which is a common term for the acoustic transducer 50. This disclosure will thus generally refer to the acoustic transducer 50 as a microphone 52 for familiarity and ease of explanation.

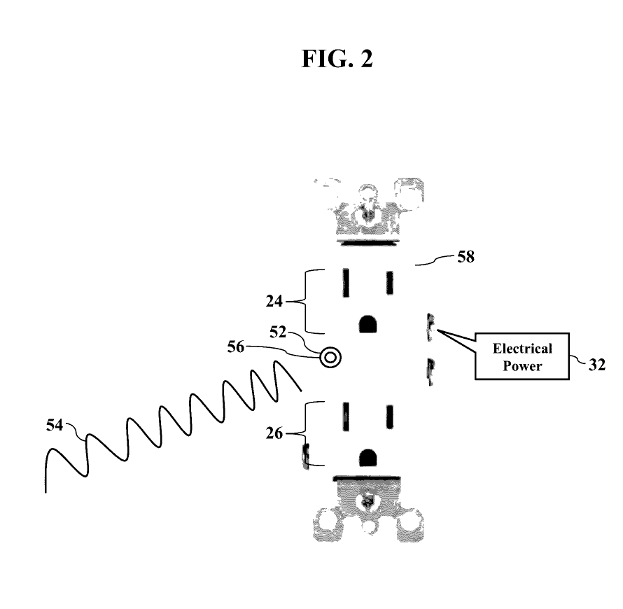

FIG. 2 better illustrates the microphone 52. The electrical receptacle 20 is illustrated without the wall plate (illustrated as reference numeral 42 in FIG. 1). The microphone 52 converts sound pressure waves 54 into electrical energy and/or signals. The microphone 52 has a sensory element 56 that converts the sound pressure waves 54 into electrical signals. For clarity, FIG. 2 illustrates the sensory element 56 exposed by a front cover 58 of the electrical receptacle 20. However, the sensory element 56 may have any location in or on the electrical receptacle 20, as later paragraphs will explain. Regardless, the sensory element 56 responds to stimulus sounds present in the room where the electrical receptacle 20 is installed. When the electrical receptacle 20 is energized (e.g., receiving the electrical power 32 from conductors 38, as FIG. 1 illustrated), electrical power 32 is provided to the electrical receptacle 20. The electrical power 32 is also supplied to the microphone 52, thus causing the microphone 52 to convert the sound pressure waves 54 into electrical energy.

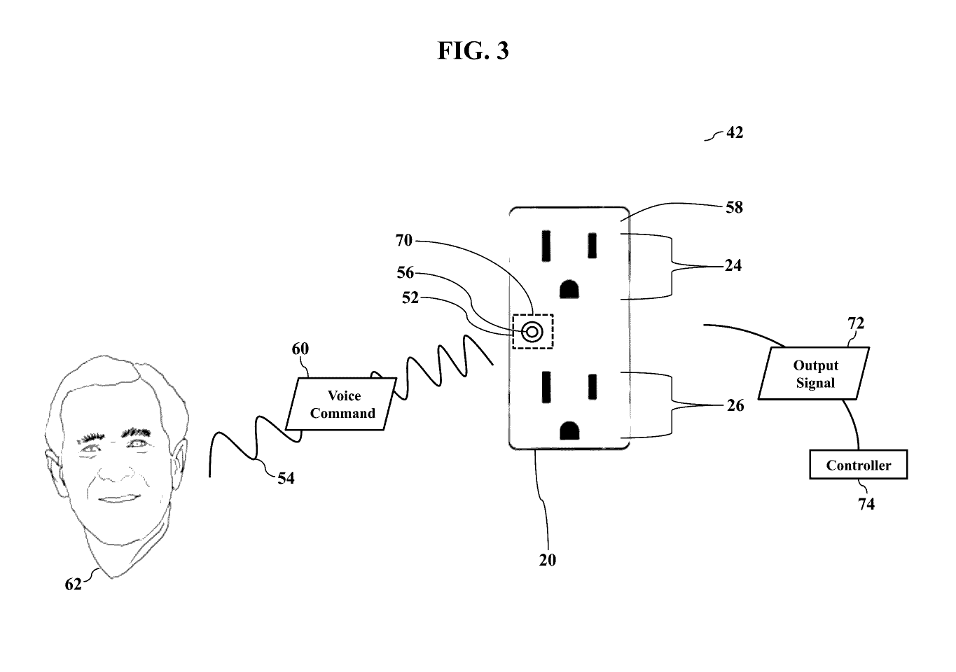

As FIG. 3 illustrates, the electrical receptacle 20 may thus respond to audible commands 60. When the electrical receptacle 20 is installed in a conventional electrical outlet box (not shown), the wall plate 42 hides some of the electrical receptacle 20 within or behind drywall sheetrock, paneling, or other stud and insulation covering. However, the outlet sockets 24 and 26 and the sensory element 56 remain exposed. The microphone 52 thus detects audible words and phrases spoken by a user 62 when in the vicinity or proximity of the electrical receptacle 20. The user's audible speech (mechanically represented as the sound pressure waves 54) propagates to the microphone 52. The user's audible speech is thus converted to electrical energy by microphone circuitry 70, which will be later explained. The microphone circuitry 70 thus generates an output signal 72 that is representative of the sound pressure waves 54. The output signal 72 may thus be sent or conveyed to a controller 74 for interpretation and action. The user may thus speak the voice commands 60 to control appliances, lights, and other automation systems.

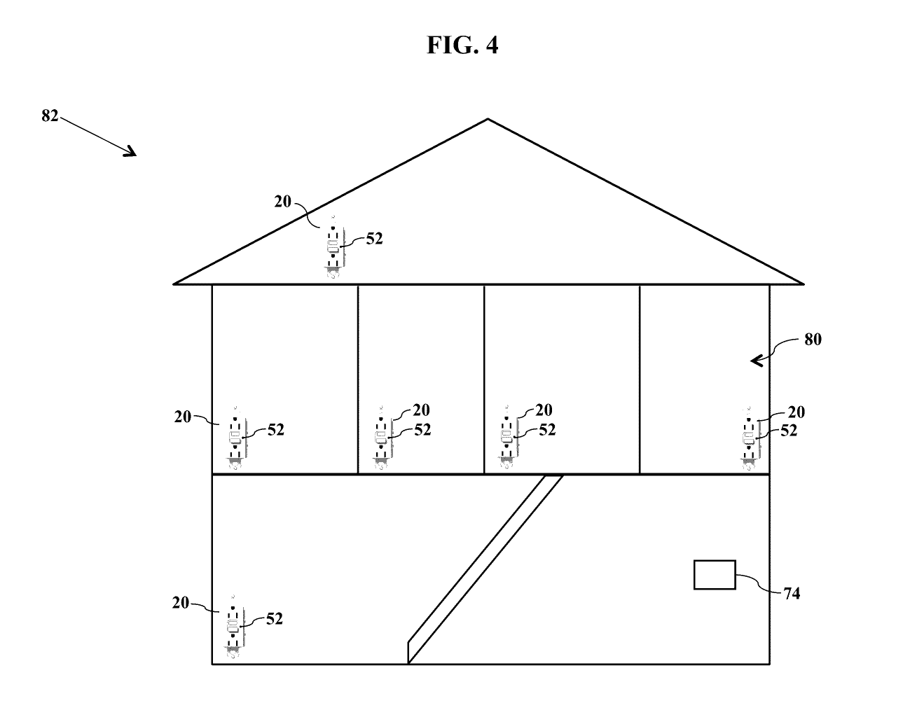

FIG. 4 illustrates a whole-home installation. Here one or more of the electrical receptacles 20 may be installed in each room 80 of a home 82. The electrical receptacle 20 may thus be deployed or installed in a bedroom, a living room, and a bathroom, thus allowing voice control throughout the home 80. The electrical receptacle 20, of course, may similarly be installed within the rooms of an office or any other facility. The controller 74 may thus respond to voice commands spoken throughout an area having electrical service. The microphone 52, integrated with the electrical receptacle 20, may also detect the speech of multiple users in the same room, thus allowing the controller 74 to distinguish and execute different commands spoken within the room.

Exemplary embodiments thus enhance the digital home experience. As more people learn about the benefits and conveniences of home control and automation, the cost and difficulty of installation may be an obstacle to wide adoption. Exemplary embodiments thus provide a simple solution that meshes with the existing electrical wiring distribution system 22 already used by nearly all homes and businesses. No extra wiring is required, and no installation concerns are added. Moreover, exemplary embodiments do not utilize or consume the conventional duplex outlet sockets 24 and 26, thus keeping the electrical receptacle 20 available for conventional power delivery to other loads. Exemplary embodiments thus present an elegant solution for enhancing verbal communication and control in interior and outside environments.

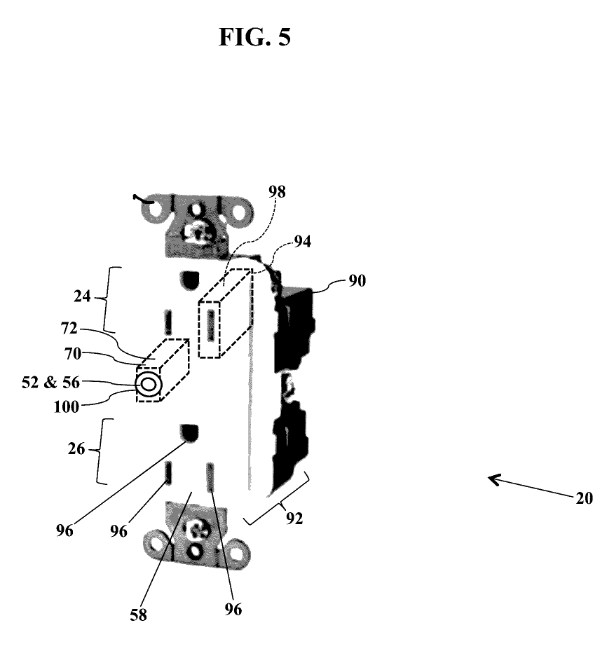

FIGS. 5-8 are more detailed illustrations of the electrical receptacle 20, according to exemplary embodiments. Many of the components of the electrical receptacle 20 are well known, so the conventional componentry need only be briefly explained. For example, the electrical receptacle 20 has the front cover 58 that mates to, or aligns with, a housing 90 to form an electrical enclosure 92. Retained within the electrical enclosure 92 are electrical terminal assemblies 94. The cover 58 has apertures 96 through which the male blades 30 of the electrical plug 28 insert (as FIG. 1 illustrated). The apertures 96 are arranged to thus define the conventional duplex female outlet sockets 24 and 26, as the reader understands. When the male blades 30 are inserted, the male blades 30 contact engagement members 98 of the electrical terminal assemblies 94, as is generally conventional. If the reader desires more details of the internal componentry, the reader is invited to consult U.S. Pat. No. 4,854,885 which is incorporated herein by reference in its entirety.

The electrical receptacle 20 may also include the microphone 52. FIG. 5 illustrates the microphone 52 mostly or substantially housed within the electrical enclosure 92 formed by the cover 58 and the housing 90. Even though the microphone 52 and the microphone circuitry 70 may be enclosed within the electrical enclosure 92, an acoustic aperture 100 in the cover 58 exposes the sensory element 56 to ambient sounds (such as the sound pressure waves 54 illustrated in FIGS. 2-3). That is, even though the microphone circuitry 70 may be enclosed within and protected by the electrical enclosure 92, the acoustic aperture 100 allows the sensory element 56 to receive or to detect the sound pressure waves 54. The microphone circuitry 70 thus generates the output signals 72 in response to the stimulus sound pressure waves 54.

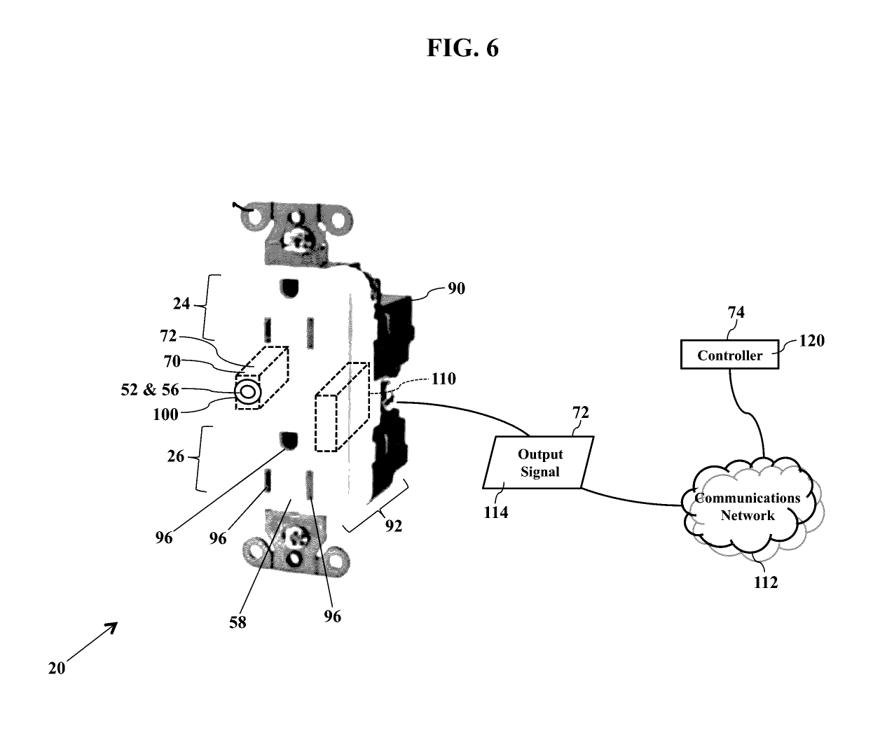

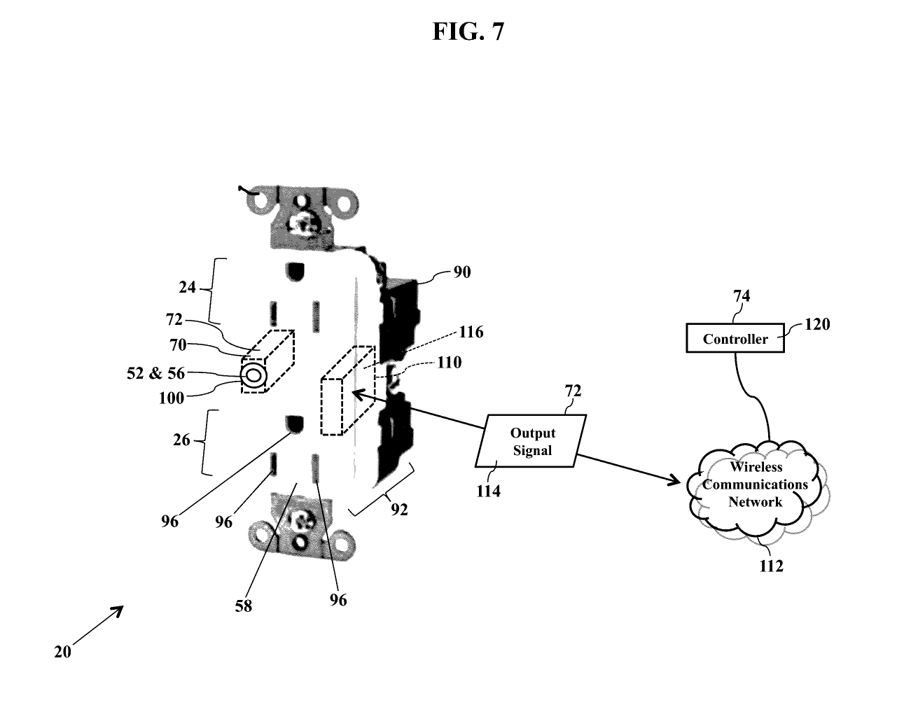

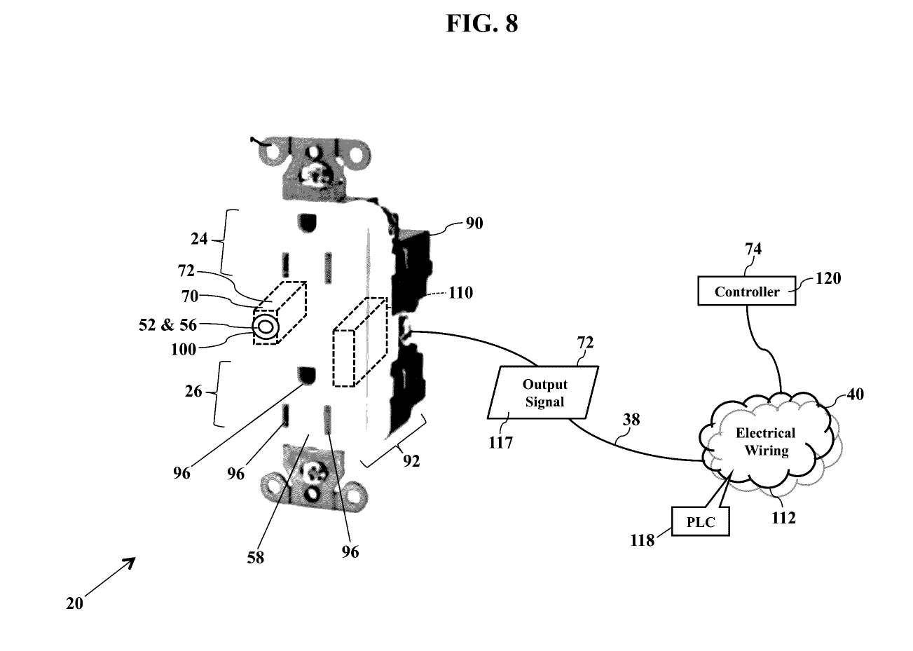

FIGS. 6-8 illustrate a network interface 110. The network interface 110 may also be mostly, substantially, or entirely housed within the electrical enclosure 92 formed by the cover 58 and the housing 90. When the microphone circuitry 70 generates the output signals 72, the output signals 72 are received by the network interface 110. The network interface 110 interconnects the electrical receptacle 20 to a communications network 112. The network interface 110 thus prepares or processes the output signals 72 according to a protocol 114. FIG. 7, for example, illustrates the network interface 110 having wireless capabilities according to a wireless protocol 114. A transceiver 116 may also be housed within the electrical enclosure 92 formed by the cover 58 and the housing 90. The transceiver 116 may thus wirelessly transmit the output signals 72 as a wireless signal via the wireless communications network 112. FIG. 8, though, illustrates the network interface 110 implementing a packetized Internet Protocol 117 and/or a power line communications (or “PLC”) protocol 118 that modulates the output signal 72 onto the conductors 38 of the electrical wiring 40. Exemplary embodiments, though, may utilize any hardware or software network interface. The network interface 110 thus sends data or information representing the output signals 72 as messages or signals to any destination, such as the network address 120 associated with the controller 74. The controller 74 thus interprets the output signals 72 for voice recognition and/or automated control.

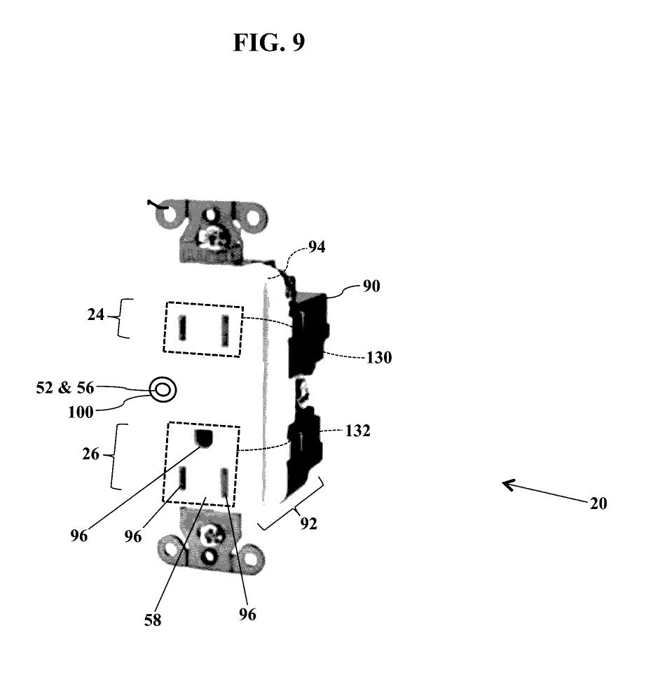

FIG. 9 illustrates a socket area 130, according to exemplary embodiments. The apertures 96 are arranged to define the conventional duplex female outlet sockets 24 and 26, as the reader understands. FIG. 9 illustrates the upper socket 24 having only two (2) of the apertures 96 for a conventional engagement with a two-prong plug, while the lower socket 26 has three (3) of the apertures 96 for conventional engagement with a grounded three-prong plug. FIG. 9 thus illustrates that the apertures 96 defining each outlet socket 24 and 26 may have any size, shape, spacing, and configuration according to governmental and industry standards, safety regulations, electrical current, and electrical voltage. The National Electrical Manufacturers Association (or “NEMA”), for example, defines standards for power plugs and receptacles used for alternating current (“AC”) mains electricity in many countries. Different combinations of contact blade widths, shapes, orientation, and dimensions are specified, based on various factors not pertinent here.

FIG. 9 also illustrates the microphone 52. The acoustic aperture 100 in the cover 58 exposes the sensory element 56 for detection of sounds. The acoustic aperture 100, though, is preferably located or configured outside the socket area 130 defined by either one of the outlet sockets 24 and 26. That is, the socket area 130 defines a surface portion or region of the cover 58 that is reserved for the physical size of the electrical plug 28 (illustrated in FIG. 1). The acoustic aperture 100 should be located outside the socket area 130. After all, if the acoustic aperture 100 were located within the socket area 130 defined by the outlet sockets 24 and 26, the blades 30 (illustrated in FIG. 1) of the electrical plug 28 may likely damage the sensory element 56. Moreover, the electrical plug 28 may obstruct the sensory element 56. For simplicity, FIG. 9 illustrates the socket area 130 having a rectangular perimeter 132 that coincides with the region of the cover 58 consumed by the electrical plugs 28 inserted into either outlet sockets 24 and 26. The socket area 130, though, may have any size and shape to suit the design and size of the electrical plug 28.

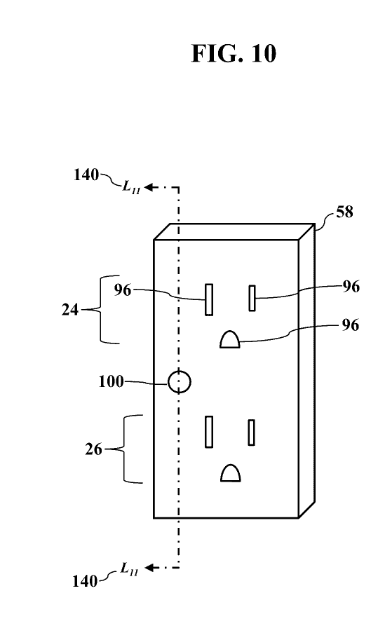

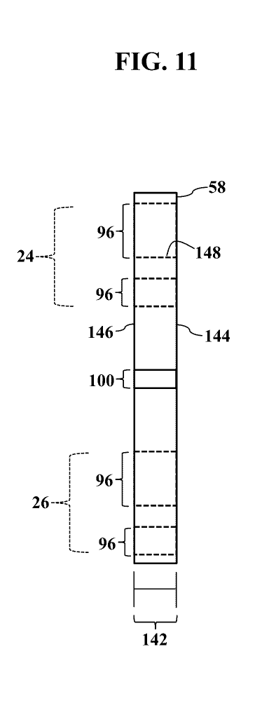

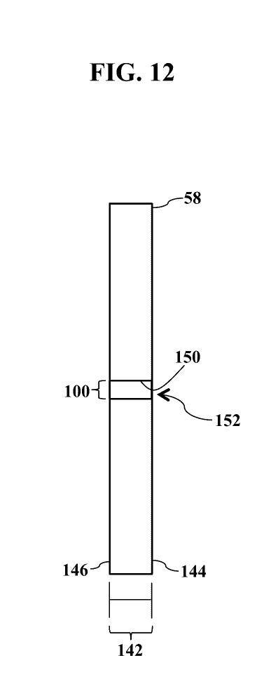

FIGS. 10-15 are more illustrations of the cover 58, according to exemplary embodiments. FIG. 10 illustrates a front view of the cover 58, while FIGS. 11-12 illustrate sectional views of the cover 58 taken along line L₁₁ (illustrated as reference numeral 140) of FIG. 10. The sectional views are enlarged for clarity of features. FIG. 11 also illustrates the apertures 96 and the outlet sockets 24 and 26 in hidden views, while FIG. 12 only illustrates the acoustic aperture 100. The cover 58 may have any shape and size to suit different configurations and needs. FIGS. 10-12 thus illustrate the cover 58 as having a simple rectangular shape. The cover 58 has a material thickness 142 defined by an inner surface 144 and an outer surface 146. Each one of the apertures 96 has a corresponding wall 148 defining an interior opening or material void having a shape of the male blade 30 that inserts therethrough (as FIG. 1 illustrated). As FIG. 12 best illustrates, the acoustic aperture 100 has an inner wall 150 defining a cross-sectional area 152. While the acoustic aperture 100 may have any cross-sectional shape, this disclosure mainly illustrates a simple circular cross-sectional shape with the circumferential inner wall 150 defining a circular hole, passage, or inlet. The acoustic aperture 100 may thus extend through the material thickness 142 from the inner surface 144 to the outer surface 146.

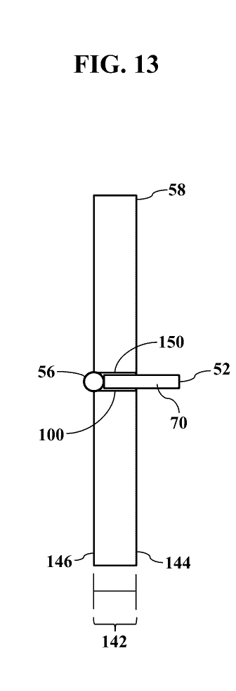

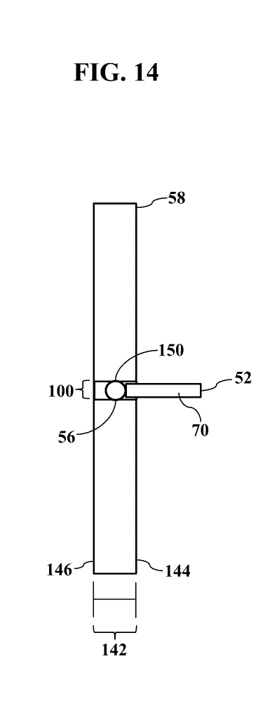

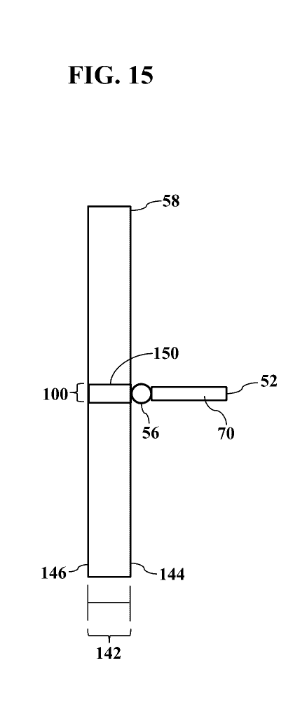

FIGS. 13-15 illustrate different positions of the sensory element 56. FIG. 13, for example, illustrates the sensory element 56 sized for insertion into and through acoustic aperture 100. The sensory element 56 may thus outwardly extend beyond the outer surface 146 of the cover 58 to detect propagating sounds. The remaining componentry of the microphone 52 (such as the microphone circuitry 70) may be located elsewhere, as desired or needed. FIG. 14, though, illustrates the sensory element 56 arranged or aligned within the acoustic aperture 100, but the sensory element 56 may not outwardly extend beyond the outer surface 146 of the cover 58. The sensory element 56, in other words, may be positioned between the inner surface 144 and the outer surface 146 of the cover 58. FIG. 15 illustrates the sensory element 56 arranged or aligned with the acoustic aperture 100, but the sensory element 56 may not extend past the inner surface 144 of the cover 58. The sensory element 56 may thus be protected from damage beyond the outer surface 146 of the cover 58, but the acoustic aperture 100 guides the sound pressure waves 54 to the sensory element 56. The acoustic aperture 100 may thus be an acoustic waveguide that reflects and directs the sound pressure waves 54 to the sensory element 56.

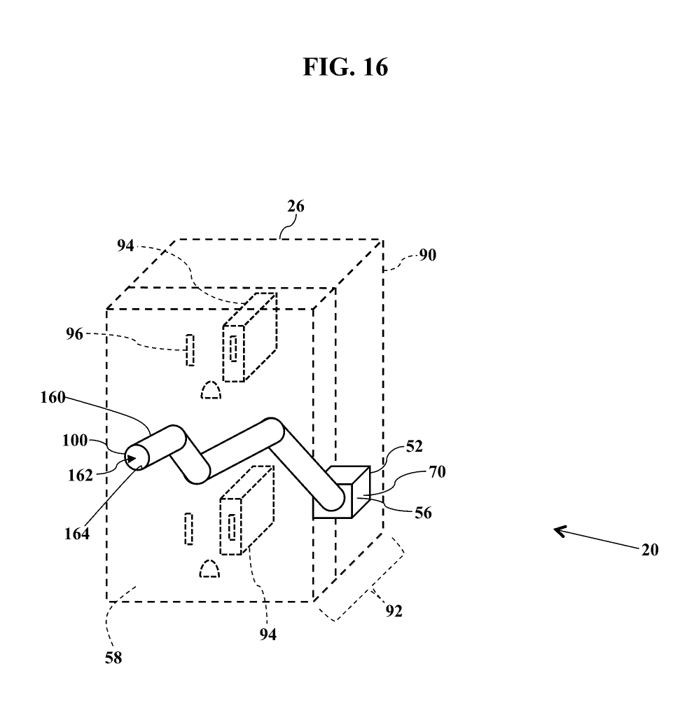

FIG. 16 illustrates an acoustic tube 160, according to exemplary embodiments. Here the electrical enclosure 92 (formed by the cover 58 and the housing 90) is shown in hidden view (along with the apertures 96) to illustratively emphasize the acoustic tube 160. There may be many situations in which the internal electrical componentry of the electrical receptacle 20 (such as the electrical terminal assemblies 94) may restrict the physical locations for the microphone 52 (such as the sensory element 56 and/or the microphone circuitry 70). The acoustic aperture 100 may act as an acoustic inlet 162 to the acoustic tube 160. The acoustic tube 160 has a length, shape, and configuration that extends from the inner surface 144 (illustrated in FIGS. 11-15) of the cover 58 to the sensory element 56 housed within the electrical enclosure 92. The acoustic tube 160 may have one or more straight sections, bends, and/or curves that snake through the internal componentry of the electrical receptacle 20 to the sensory element 56 and/or the microphone circuitry 70. The acoustic tube 160 may thus be an acoustic waveguide that reflects and directs the sound pressure waves 54 around or between the electrical terminal assemblies 94 to the sensory element 56. The acoustic tube 160 may thus have an inner tubular wall 164 defining any cross-sectional shape or area. For simplicity, FIG. 16 illustrates a circular cross-section that aligns with or mates with the acoustic aperture 100. The sensory element 56 may thus be physically located at any position or location within the electrical enclosure 92 formed by the cover 58 and the housing 90. The acoustic tube 160 directs the sound pressure waves 54 (illustrated in FIGS. 2 & 3) to the sensory element 56, regardless of its location within the electrical receptacle 20. The acoustic tube 160 may have a cross-sectional shape, diameter, length, and routing to suit any design need or packaging limitation.

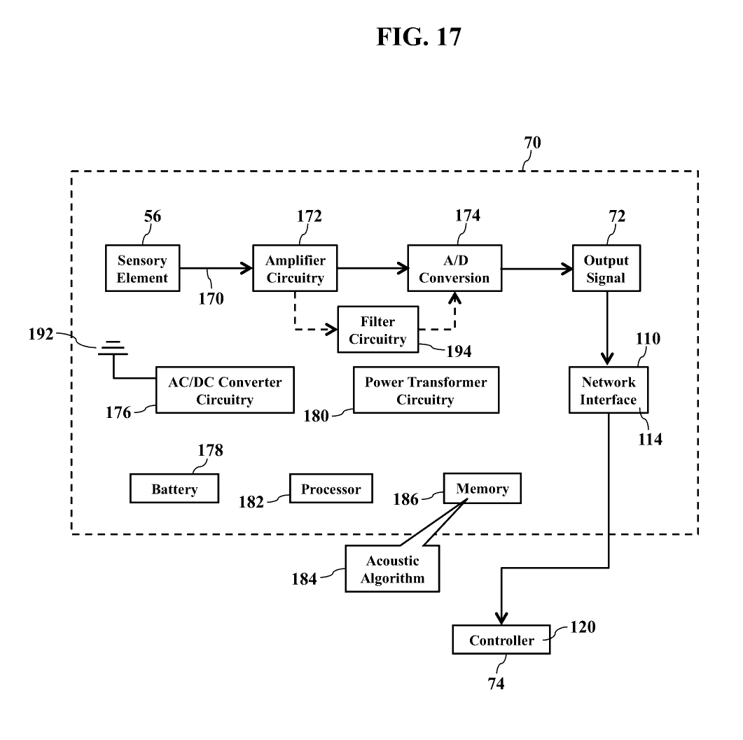

FIG. 17 is a block diagram of the microphone circuitry 70, according to exemplary embodiments. There are many different microphone designs and circuits, so FIG. 17 only illustrates the basic components. The sensory element 56 detects audible words and phrases spoken by a user when in the vicinity or proximity of the electrical receptacle 20 (as illustrated by FIGS. 1-9). The sensory element 56 converts the sound pressure waves 54 (illustrated in FIGS. 2 & 3) into electrical energy 170 having a current, voltage, and/or frequency. An output of the sensory element 56 may be small, so amplifier circuitry 172 may be used. If the sensory element 56 produces an analog output, an analog-to-digital converter 174 may then be used to convert an output of the amplifier circuitry 172 to a digital form or signal. The microphone circuitry 70 thus generates the output signal 72 that is representative of the sound pressure waves 54. The output signals 72 are received by the network interface 110 and prepared or processed according to the protocol 114. The network interface 110, for example, may wirelessly send the output signals 72 using a cellular, WI-FI®, or BLUETOOTH® protocol or standard. However, the network interface 110 may module the output signals 72 according to power line communications (“PLC”) protocol or standard. Regardless, the network interface 110 addresses the output signals 72 to any destination, such as the network address 120 associated with the controller 74. The controller 74 thus interprets the output signals 72 for voice recognition and/or automated control.

Exemplary embodiments may also include power conversion. As the reader may realize, the electrical receptacle 20 receives alternating current (“AC”) electrical power (current and voltage). The microphone circuitry 70, though, may require direct current (“DC”) electrical power. The microphone circuitry 70 may thus include an AC/DC converter circuitry 176 that converts the alternating current electrical power (supplied to the electrical terminal assemblies 94) into direct current electrical power. The direct current electrical power is thus distributed to the sensory element 56 and to the microphone circuitry 70. The microphone circuitry 70 may further include a battery 178 for continued operation when the alternating current (“AC”) electrical power is not available.

Exemplary embodiments may also include power transformation. The alternating current electrical power provided by the electrical wiring distribution system 22 may be at a different voltage that required by the microphone circuitry 70. For example, in North America the electrical grid delivers 120 Volts AC at 60 Hz. The microphone circuitry 70, though, may require 5 Volts DC or even less. Power transformer circuitry 180 may thus be included to transform electrical power to a desired driver voltage and/or current.

Exemplary embodiments may utilize any microphone technology. Some microphones have a vibrating diaphragm. Some microphones are directional and others are omnidirectional. Different microphone designs have different frequency response characteristics and different impedance characteristics. Some microphones are even manufactured using micro-electro-mechanical systems (or “MEMS”) technology. The microphone technology is mot important, as exemplary embodiments may be utilized with any microphone technology or manufacturing process.

Exemplary embodiments may be processor controlled. The electrical receptacle 20 and/or the microphone circuitry 70 may also have a processor 182 (e.g., “μP”), application specific integrated circuit (ASIC), or other component that executes an acoustic algorithm 184 stored in a memory 186. The acoustic algorithm 184 is a set of programming, code, or instructions that cause the processor 182 to perform operations, such as commanding the sensory element 56, the amplifier circuitry 172, the analog-to-digital converter 176, the power transformer circuitry 180, and/or the network interface 110. Information and/or data may be sent or received as packets of data according to a packet protocol (such as any of the Internet Protocols). The packets of data contain bits or bytes of data describing the contents, or payload, of a message. A header of each packet of data may contain routing information identifying an origination address and/or a destination address.

A connection to electrical ground 190 is also provided. Because the electrical receptacle 20 is physically connected to the conductors 38 of the electrical wiring 40 (as FIG. 1 illustrates), the electrical receptacle 20 may have an available physical connection to one of the conductors 38 providing electrical ground 190. Even one of the conductors 38 connected to neutral may provide the electrical ground 190.

The microphone circuitry 70 may optionally include filter circuitry 194. Exemplary embodiments may be tuned or designed for certain ranges or bands of frequencies. For example, the human voice is typically very low frequencies (85-300 Hz). If the electrical receptacle 20 is used for voice control, the user will likely not speak commands outside the human voice range of frequencies. Exemplary embodiments may thus ignore, or filter out, frequencies not of interest (such as inaudible frequencies) to save processing capability. The filter circuitry 194 may thus be used to avoid wasting resources on unwanted or undesired frequencies.

Exemplary embodiments may be applied regardless of networking environment. Exemplary embodiments may be easily adapted to networking technologies using cellular, WI-FI®, near field, and/or BLUETOOTH® standards. Exemplary embodiments may be applied to any portion of the electromagnetic spectrum and any signaling standard (such as the IEEE 802 family of standards, GSM/CDMA/TDMA or any cellular standard, and/or the ISM band). Exemplary embodiments may be applied to the radio-frequency domain and/or the Internet Protocol (IP) domain. Exemplary embodiments may be applied to any computing network, such as the Internet (sometimes alternatively known as the “World Wide Web”), an intranet, a local-area network (LAN), and/or a wide-area network (WAN). Exemplary embodiments may be applied regardless of physical componentry, physical configuration, or communications standard(s).

Exemplary embodiments may utilize any processing component, configuration, or system. Any processor could be multiple processors, which could include distributed processors or parallel processors in a single machine or multiple machines. The processor can be used in supporting a virtual processing environment. The processor could include a state machine, application specific integrated circuit (ASIC), programmable gate array (PGA) including a Field PGA, or state machine. When any of the processors execute instructions to perform “operations”, this could include the processor performing the operations directly and/or facilitating, directing, or cooperating with another device or component to perform the operations.

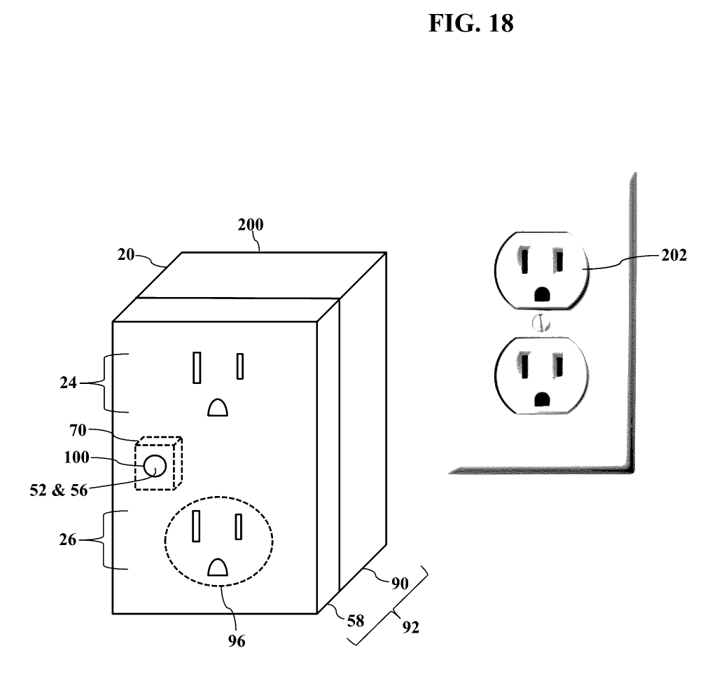

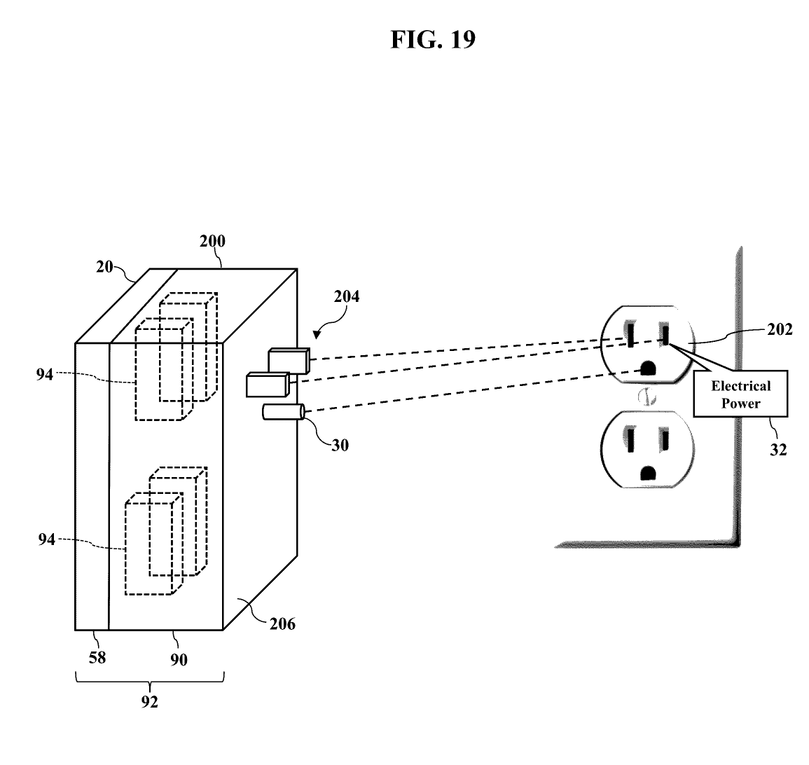

FIGS. 18-19 illustrate a retrofit option, according to exemplary embodiments. Even though the electrical receptacle 20 provides a useful automation control component, some people may be leery of installation. As the conductors 38 of the electrical wiring distribution system 22 (illustrated in FIG. 1) convey the electrical power 32, there is a concern of electrical shock if improperly installed. Professional, licensed installation will likely be required for most people, which could be expensive.

FIGS. 18-19 thus illustrate a retrofit configuration 200. Here the electrical receptacle 20 may plug into an existing receptacle 202 already installed and connected to the electrical wiring distribution system 22 (illustrated in FIG. 1) in the home or business. That is, as FIG. 18 best illustrates, here the enclosure 92 of the electrical receptacle 20 resembles a self-contained rectangular box or “brick.” The apertures 96 in the front cover 58 define the female outlet sockets 24 and 26, as earlier explained. The acoustic aperture 100 exposes the microphone circuitry 70 to sounds. As FIG. 19 illustrates, though, the electrical receptacle 20 also includes a backside male plug 204. The backside male plug 204 has the conventional male blades 30 that protrude through a back wall 206 of the housing 90. The male blades 30 conventionally insert into and engage the existing receptacle 202 that is already installed in a wall of the home or business. The male blades 30 of the backside male plug 204 thus receive the electrical power 32 that is supplied by the existing receptacle 202. However, the male blades 30 also electrically connect to the electrical terminal assemblies 94 retained within the electrical enclosure 92 formed by the front cover 58 and the housing 90.

The retrofit configuration 200 also includes the microphone 52. The microphone 52 may again be mostly or substantially housed within the electrical enclosure 92 formed by the cover 58 and the housing 90. The acoustic aperture 100 exposes the sensory element 56 of the microphone 52. When the retrofit configuration 200 is plugged into the existing receptacle 202, the microphone circuitry 70 still receives the electrical power 32 from the electrical terminal assemblies 94, but now the electrical terminal assemblies 94 are electrically connected to the existing receptacle 202.

The retrofit configuration 200 thus presents an easy installation option. The user need only insert the backside male plug 204 (extending through the back wall 206 of the housing 90) into the existing receptacle 202 installed in the wall. The retrofit configuration 200 provides acoustic capabilities via the microphone 52, while still providing the two (2) female outlet sockets 24 and 26. The electrical receptacle 20 thus piggybacks onto the existing receptacle 202 already installed in the wall. No removal and replacement of the existing receptacle 202 is needed. No conductors need be disconnected and reconnected. Any possibility of electrical injury is greatly reduced. The retrofit configuration 200 is thus very simple and safe.

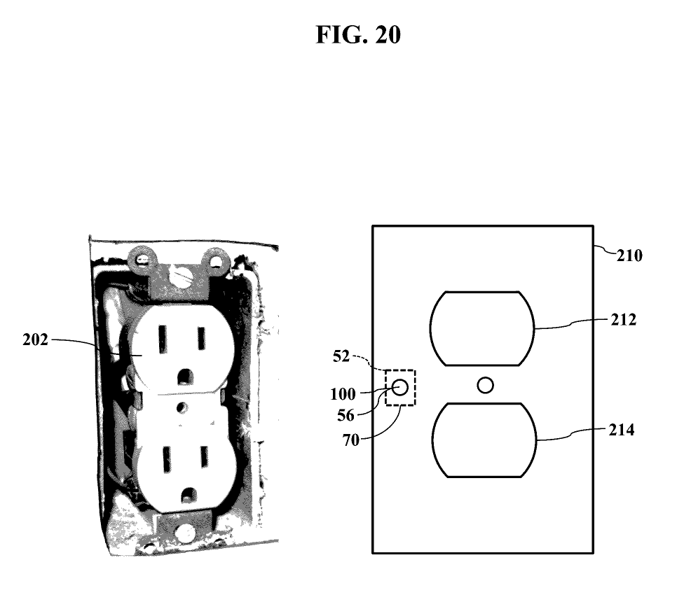

FIGS. 20-23 illustrate another retrofit option, according to exemplary embodiments. Here the user need only remove and replace an existing wall plate that finishes the existing receptacle 202 already installed in the wall. As the reader understands, the conventional wall plate covers the existing receptacle 202 installed in the wall. Here the user need only remove the existing wall plate and install an acoustic wall plate 210, according to exemplary embodiments. The acoustic wall plate 210 includes conventional socket apertures 212 and 214 that fit onto or slide over the existing receptacle 202. However, the acoustic wall plate 210 also includes the acoustic aperture 100 that exposes the microphone 52. That is, here the microphone 52 (e.g., the sensory element 56 and the microphone circuitry 70) may be integrated into or with the wall plate that finishes the existing receptacle 202. The acoustic wall plate 210 thus provides another retrofit option for the user. The user may thus simply install the acoustic wall plate 210 to provide voice control capability to a home or business.

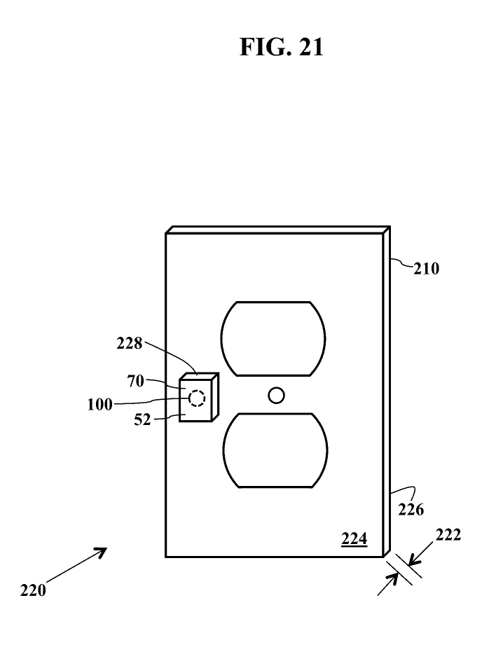

FIG. 21 illustrates a backside 220 of the acoustic wall plate 210. The acoustic aperture 100 extends through a plate thickness 222 defined by an inner surface 224 and a front, outer surface 226. The acoustic aperture 100 has the inner wall 150 defining its cross-sectional area (best illustrated by FIG. 12). The sensory element 56 of the microphone 52 may thus align with the acoustic aperture 100 to detect propagating sounds. The microphone 52 may thus be a small component or chip 228 (such as a MEMS device) that secures to the inner surface 224 of the acoustic wall plate 210. The microphone 52 may thus adhesively adhere to the inner surface 224. The microphone 52 may snap into a molded compartment that acoustically communicates with the acoustic aperture 100. The microphone 52 may even be molded within the plate thickness 222 between the inner surface 224 and the outer surface 226. However the microphone 52 is secured, the sensory element 56 preferably aligns with the acoustic aperture 100 to detect sounds without obstruction of electrical plugs (not shown for simplicity).

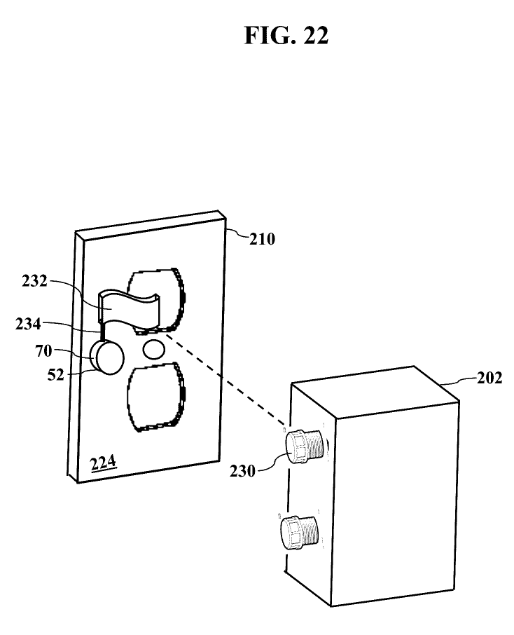

FIG. 22 illustrates an electrical connection. The microphone 52 requires the electrical power 32 for operation (as illustrated in FIGS. 1 & 2). The acoustic wall plate 210 may thus have a means of contacting the “hot” terminal screw 230 in the existing receptacle 202 (already installed in the wall). FIG. 22, for example, illustrates a spring finger 232. The spring finger 232 has an end or portion that is retained to or in the inner surface 224 of the acoustic wall plate 210. The spring finger 232 has an opposite end that contacts the “hot” terminal screw 230 when the acoustic wall plate 210 is installed onto or over the existing receptacle 202. A line, wire, or via 234 connects the spring finger 232 to the microphone circuitry 70. When the existing receptacle 202 is energized, the spring finger 232 thus supplies or conveys the electrical power 32 from the “hot” terminal screw 230 to the microphone circuitry 70. The microphone circuitry 70 thus receives the electrical power 32 for operation.

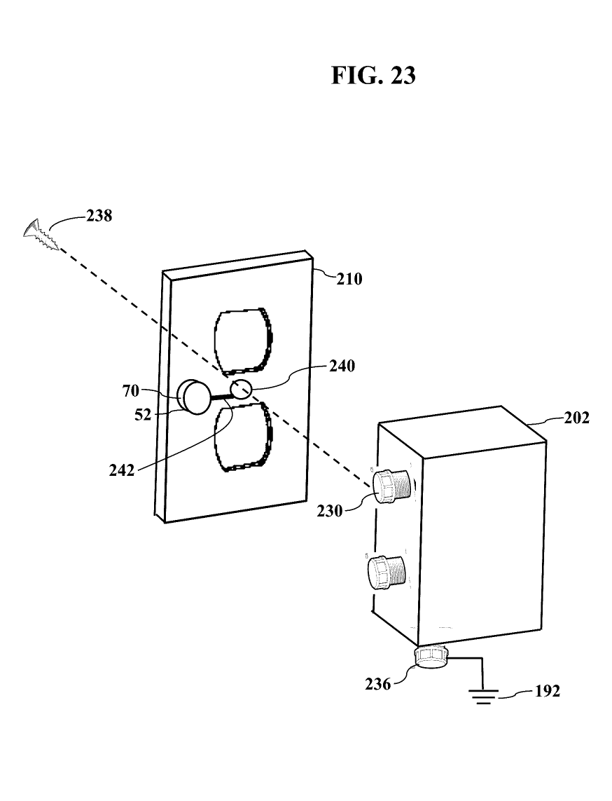

As FIG. 23 illustrates, the connection to electrical ground 192 is also provided. The existing receptacle 202 may also have a ground terminal screw 236 connected to the electrical ground 192, as is conventional installation. When a mounting screw 238 is installed through a screw hole 240 in the acoustic wall plate 210, the mounting screw 238 makes an electrical connection to the electrical ground 192, as is also conventional installation. The existing receptacle 202 has internal componentry that grounds the mounting screw 238 for safety. Here, though, the acoustic wall plate 210 may have a ground line, wire, or via 242 that electrically connects the mounting screw 238 to the microphone circuitry 70. When the existing receptacle 202 is grounded, the electrical ground 192 is supplied to the microphone circuitry 70.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. An electrical receptacle, comprising:
a housing retaining electrical terminal assemblies adapted for physical connection to conductors of an electrical power distribution system;
a cover mating to the housing, the cover having apertures exposing engagement members of the electrical terminal assemblies;
a microphone having a sensory element exposed through the cover of the electrical receptacle; and
circuitry housed within the housing and having an electrical connection to at least one of the electrical terminal assemblies;
wherein the circuitry converts alternating current electrical power when present on the conductors into direct current electrical power for providing electrical power to the microphone.

2. The electrical receptacle of claim 1, further comprising an acoustic aperture in the cover of the electrical receptacle, the acoustic aperture exposing the sensory element of the microphone.

3. The electrical receptacle of claim 2, wherein the sensory element of the microphone protrudes through a material thickness of the cover of the electrical receptacle.

4. The electrical receptacle of claim 2, wherein the acoustic aperture exposes the sensory element outside a socket area of the cover reserved as an electrical socket for an electrical plug, the socket area defined by an arrangement of the apertures through which blades of the electrical plug insert therethrough for engagement with the engagement members of the electrical terminal assemblies.

5. The electrical receptacle of claim 2, wherein the acoustic aperture exposes the sensory element outside a duplex socket area of the cover reserved as electrical sockets for electrical plugs, the duplex socket area defined by an arrangement of the apertures through which blades of the electrical plugs insert therethrough for engagement with the engagement members of the electrical terminal assemblies.

6. The electrical receptacle of claim 1, further comprising a ground connection to electrical ground.

7. The electrical receptacle of claim 1, further comprising a network interface to a power-line communications network provided by the conductors of the electrical power distribution system.

8. The electrical receptacle of claim 1, further comprising a network interface to a wireless communications network.

9. The electrical receptacle of claim 1, further comprising filter circuitry housed within the housing, wherein the filter circuitry receives the direct current electrical power converted by the power circuitry and filters signals representing inaudible frequencies.

10. The electrical receptacle of claim 2, further comprising analog to digital conversion circuitry housed within the housing, wherein the analog to digital conversion circuitry receives the direct current electrical power converted by the power circuitry and converts an analog output signal generated by the sensory element of the microphone to a digital signal.

11. The electrical receptacle of claim 1, further comprising amplifier circuitry housed within the housing, wherein the amplifier circuitry receives the direct current electrical power converted by the power circuitry and amplifies an output signal generated by the sensory element of the microphone.

12. An electrical receptacle, comprising:
a housing retaining electrical terminal assemblies adapted for physical connection to conductors of an electrical power distribution system;
a cover mating to the housing to form an electrical enclosure, the cover having apertures exposing female engagement members of the electrical terminal assemblies for engagement with male blades of an electrical plug;
a microphone housed within the electrical enclosure, the microphone having a sensory element protruding through an acoustic aperture in the cover of the electrical receptacle;
a processor housed within the electrical enclosure; and
a memory housed within the electrical enclosure, the memory storing instructions that when executed causes the processor to perform operations, the operations comprising:
converting alternating current electrical power when present on the conductors into direct current electrical power;
converting an analog output signal generated by the sensory element of the microphone into a digital signal;
amplifying the digital signal to generate an amplified signal; and
sending the amplified signal via a network interface to a destination network address.

13. The electrical receptacle of claim 12, further comprising a ground connection to electrical ground.

14. The electrical receptacle of claim 12, wherein the electrical enclosure houses the network interface.

15. The electrical receptacle of claim 14, wherein the network interface interfaces with a wireless communications network.

16. The electrical receptacle of claim 14, wherein the network interface interfaces with a power-line communications network provided by the conductors of the electrical power distribution system.

17. The electrical receptacle of claim 12, wherein the operations further comprise filtering signals representing inaudible frequencies.

18. The electrical receptacle of claim 12, wherein the operations further comprise retrieving the destination network address from the memory.

19. An electrical receptacle, comprising:
a housing retaining electrical terminal assemblies therein, the electrical terminal assemblies adapted for physical connection to conductors of an electrical power distribution system;
a cover mating to the housing to form an electrical enclosure, the cover having apertures exposing female engagement members of the electrical terminal assemblies, the apertures arranged as electrical sockets for female engagement with male blades of an electrical plug;
an acoustic aperture extending through a material thickness of the cover, the acoustic aperture arranged outside a socket area of the cover that is reserved for the electrical plugs that engage the electrical sockets;
a microphone housed within the electrical enclosure, the microphone having a sensory element protruding through the acoustic aperture in the cover of the electrical receptacle, the sensory element generating an analog signal in response to sound waves; and
circuitry housed within the electrical enclosure and having an electrical connection to at least one of the electrical terminal assemblies;
wherein the circuitry converts alternating current electrical power when present on the conductors into direct current electrical power for providing electrical power to the microphone.

20. The electrical receptacle of claim 19, further comprising a network interface housed within the electrical enclosure.
